(19) United States
(12) Patent Application Publication
(10) Pub. No.: US 2006/0026099 A1
(43) Pub. Date: Feb. 2, 2006

(54) Voice/data financial transaction communications device

(76) Inventors: Barry Danz, Alpharetta, GA (US); Paul Wilson, Suwanee, GA (US)

Correspondence Address: Bambi F. Walters, P.O. Box 5743, Williamsburg, VA, 23188, US

(21) Appl. No.: 10/903,990

(22) Filed: Jul. 30, 2004

(51) Int. Cl. G06Q 40/00

(52) U.S. Cl. 705/44

(57) ABSTRACT

A voice/data financial transaction communications device having an integrated credit card processing terminal, a financial transaction computer program product, and a router detects and decodes financial data, associates the financial data with other transactional data, creates a financial transaction request, and communicates the request to an authorization communications address via a data communications network and/or a telecommunications network. In response to the request, a message is communicated and presented to the voice/data financial transaction communications device with payment authorization (or alternate instructions) to complete the financial transaction.

### CROSS REFERENCE TO RELATED APPLICATIONS

This application relates to applicants' co-pending application entitled “Financial Transaction Processing Via Combined Voice/Data Financial Transaction Communications Device and Call Control and Service Logic System,” (BS040090, 04-BS015) filed simultaneously herewith and of which the “Brief Summary of the Invention” and “Detailed Description of the Invention” sections are incorporated herein by this reference.

This application relates to applicants' co-pending application entitled “Voice/Data Financial Transaction Monitoring Methods and Systems,” (BS040091/04-BS016) filed simultaneously herewith and of which the “Brief Summary of the Invention” and “Detailed Description of the Invention” sections are incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention generally relates to Internet telephony, and, more particularly relates to systems and methods of processing a financial transaction from a Voice-Over Internet Protocol communications device over a data communications network and/or a telecommunications network.

2. Description of Related Art

Internet Telephony also referred to herein as Voice-Over Internet Protocol (VoIP), Voice-Over Network (VoN), and/or Internet Protocol Telephony (IP Telephony), is experiencing explosive growth and marked improvements in reliability and sound quality. The improved Internet Telephony communications are, in large part, due to upgrading the internet backbone with better switching fabrics, such as Asynchronous Transfer Mode (ATM), and also due to implementation of new communications standards, such as standards for transport protocols, directory services, and/or audio codec format.

These improvements and growth of IP telephony are influencing traditional telecommunications networks. The Public Switched Telephone Network (PSTN) is integrating with data networks, such as the Internet Protocol (IP) Network. Conventional voice technology (e.g., a Plain Old Telephone (POTS) call) processes the analog communications signal over a circuit-switched telecommunications network, however with advances in IP telephony, voice technology is reaching towards a packet-switched data network. Rather than risking just “jumping” over to the IP-based communications network that still faces many engineering and distribution challenges, communications providers (e.g., telecommunications service providers, internet service providers, and so on) use a hybrid network that relies on proven performance and a large distribution of the Public Switched Telephone Network (PSTN) with the IP-based network to leverage the assets of both networks.

Along with these improvements come new challenges for the industry. For example, a need exists for better, more efficient and secure financial transactions from an Internet telephony communications device. Today, most merchants process financial transactions with an ATM/debit/credit card processing service to receive payment from a customer. Equipment for the ATM/debit/credit card processing service typically includes a terminal, an analog phone, and a router. When the customer makes a purchase (e.g., buys groceries, gas, and so on) and uses a credit, debit, or ATM card (hereinafter referred to as a “credit card”), the customer typically swipes, inserts, and/or otherwise presents a magnetic reader of his/her card to a credit card processing terminal at the point of sale (POS). The credit card terminal device reads the magnetic reader, dials an associated card authorization number, routes and communicates a payment request to the credit card's authorization center via the PSTN, and then communicates a response to the request (e.g., approval or denial) from the credit card's authorization center to the terminal. This authorization process sometimes encounters a variety of problems including errors reading the credit card, hardware and equipment malfunctions, and communications problems. For example, if a router that connects multiple terminals at check out counters (POS) in a grocery store malfunctions, then no credit card transactions can be processed from any of the terminals until the router is fixed. Consequently, the grocery store may lose money when customers become frustrated or do not have another payment alternative. Additionally, today's credit card processing equipment tends to be somewhat large and bulky, taking up counter space that could be used to promote merchandise, and consequently lead to other financial losses.

Accordingly, systems and methods are needed for a credit card authorization process from a VoIP communications device over data networks and/or telecommunications networks. Additionally, methods and systems that provide increased efficiency are further needed for these VoIP credit card related financial transactions.

### SUMMARY OF THE INVENTION

This invention addresses the above needs and other needs by providing systems, methods, computer programs, and/or computer program products to process and route a financial transaction request from a voice/data financial transaction communications device. This invention, in particular, provides a VoIP phone equipped with a router, a credit card processing terminal, and a VoIP financial transaction communications computer software product. The VoIP financial transaction communications computer software product (also referred to herein as the “VoIP Financial Transaction Module”) receives data of a financial card medium (e.g., Visa, MasterCard, debit cards, gift cards, store credit, and so on) from a card reader subsystem in its credit card processing terminal, then analyzes and associates the card's financial data with transactional data. Thereafter, a financial transaction request is communicated to a financial authorization address via a communications network. In response to the request, an authorization (or an alternate message) is communicated from the financial authorization address via the communications network to the voice/data financial transaction communications device. According to further embodiments, the voice/data financial transaction communications device may print a receipt documenting the financial transaction. Because the voice/data financial transactions communications device leverages communications assets, the voice/data financial transaction communications device may simultaneously process the financial transaction and while also providing a voice communications connection, so that a merchant and/or another user could use the voice/data financial transaction communications device for a telephone call while the financial transaction is in progress.

According to embodiments of this invention, a voice/data financial transactions communications system includes a VoIP communications device equipped with a router, a card reader subsystem, and a VoIP financial transactions module stored in memory. The VoIP Financial Transaction Module includes a computer program product that accesses and associates financial data from a received financial card medium with transactional data to prepare a financial transaction request. The financial card medium data includes a financial institution authorization communications address, a card identifier, an expiration date, and/or a monetary limit for a financial transaction. The transactional data includes data identifying a merchant, such as, for example, a merchant communications address, a merchant identifier, and/or a financial institution of the merchant, data identifying a good and/or service of the financial transaction, and data identifying a monetary amount of the financial transaction. The router communicates the financial transaction request to the financial card's institution authorization communications address via a communications network, such as, for example, a telecommunications network (e.g., Public Switched Telephone Network (PSTN)), a data communications network (e.g., an Internet Protocol communications network), and/or a satellite network. The financial transaction request includes the financial card medium data and transactional data including the monetary amount for the financial transaction. In response to the request, a financial institution of the financial institutional authorization communications address processes the request and communicates an authorization message with approval (or, alternatively, denial or another message) of the financial transaction request to the voice/data financial transaction communications system. The VoIP Financial Transaction Module receives and processes the authorization message to complete the financial transaction. In further embodiments, the voice/data financial transaction communications device includes a printer, and the VoIP Financial Transaction Module may instruct the printer to print out a receipt or other documentation of the financial transaction.

According to other embodiments of this invention, a computer program product includes a computer readable medium and a VoIP Financial Transaction Module stored on the computer readable medium. Similar to the above embodiment, the VoIP Financial Transaction Module detects and receives data from a financial card medium and associates the financial card medium data with transactional data to create a financial transaction request. The VoIP Financial Transaction Module communicates the financial transaction request to a financial institution authorization communications address, and, in response to the request, receives an authorization (or alternate message) from the financial institution authorization communications address.

According to other embodiments of this invention, a method of processing financial transactions includes receiving data of a financial card medium from a card reader subsystem of a voice/data financial transaction communications device, analyzing and associating the financial card's data with other transactional data, preparing a financial transaction request, communicating the request to a financial institution authorization communications address, and, in response to the request, receiving an authorization (or alternate message) from the financial institution authorization communications address Further embodiments, include printing a receipt or other documentation of the financial transaction.

Other systems, methods, and/or computer program products according to embodiments will be or become apparent to one with skill in the art upon review of the following drawings and detailed description. It is intended that all such additional systems, methods, and/or computer program products be included within this description, be within the scope of this invention, and be protected by the accompanying claims.

### BRIEF DESCRIPTION OF THE DRAWINGS

The above and other embodiments, objects, uses, advantages, and novel features of this invention are more clearly understood by reference to the following description taken in connection with the accompanying figures, wherein:

FIG. 1 illustrates a block diagram of an operating system according to some of the exemplary embodiments of this invention;

FIG. 2 illustrates an operating environment for processing financial transactions according to some of the exemplary embodiments of this invention;

FIG. 3 illustrates another example of an operating environment for processing financial transactions according to some of the exemplary embodiments of this invention;

FIG. 4 illustrates still another operating environment for processing financial transactions according to some of the exemplary embodiments of this invention;

FIG. 5 illustrates another example of an operating environment for processing financial transactions according to some of the embodiments of this invention;

FIG. 6 illustrates a block diagram of an alternative operating system according to exemplary embodiments of this invention; and

FIG. 7 illustrates a flowchart of a method for processing financial transactions according to exemplary embodiments of this invention.

### DETAILED DESCRIPTION OF THE DRAWINGS

This invention now will be described more fully hereinafter with reference to the accompanying drawings, in which exemplary embodiments are shown. This invention may, however, be embodied in many forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, flowcharts, illustrations, and the like represent conceptual views or processes illustrating systems, methods, and computer program products embodying this invention. The functions of the various elements shown in the figures may be provided through the use of dedicated hardware, as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

This invention provides systems, methods, and computer program products for processing, routing, and/or otherwise communicating a financial transaction between a voice/data financial transaction communications device and a credit card authorization communications address. The voice/data financial transaction communications device is a Voice over Internet Protocol (VoIP) phone having an integrated credit card processing terminal, a VoIP Financial Transaction Module, and a router. The VoIP Financial Transaction Module detects and decodes financial data from the credit card processing terminal (e.g., a credit card's magstripe is swiped through a card reader subsystem). The VoIP Financial Transaction Module then associates the financial data with other transactional data to create a financial transaction request. As used herein, the term “financial data” includes data of a financial institution authorization communications address, a card identifier, an expiration date, a monetary limit for a financial transaction, and/or a cardholder (e.g., the cardholder's name). As used herein, the term “transactional data” includes data identifying a merchant, such as a merchant communications address, a merchant identifier, and/or a financial institution of the merchant, data identifying a good and/or service of the financial transaction, and data identifying a monetary amount of the financial transaction. Thereafter, the VoIP Financial Transaction Module communicates the request to the financial institution authorization communications address. In response to the request, the VoIP Financial Transactions Module receives an authorization message (e.g., approval, denial, and/or an alternate message about the transaction) and completes the financial transaction. In some embodiments, the VoIP Financial Transaction Module may instruct a printer to print a receipt or other documentation of the financial transaction. The voice/data financial transaction communications device provides a creative, integrated communications solution that incorporates conventional credit card processing equipment with the communications assets of a VoIP phone. An advantage of the voice/data financial transaction communications device is to provide communications with the financial institution (e.g., the request and authorization) and to also provide additional communications with another party. For example, if a merchant has an incoming call to the voice/data financial transaction communications device during the financial transaction, then merchant may answer the call and have a conversation at the same time (without disabling the financial transaction communications). And, similarly, if the merchant has an incoming electronic data message (e.g., an email), then the merchant may view, read, and/or listen to the electronic data message at the same time as the processing of the financial transaction. Thus, the voice/data financial transactions communications device streamlines communications and financial transaction processing. Another advantage is using the VoIP Financial Transaction Module to create the request using financial data of the card medium and transactional data, to control communications connections, and to manage financial transaction communications including the request and/or the authorization. For example, the VoIP Financial Transaction Module may communicate with other systems and applications to provide up-to-date merchant data, to provide another means of tracking goods and/or services, and/or to determine alternate communications connections with the authorization financial institution communications address (e.g., when a server is unavailable).

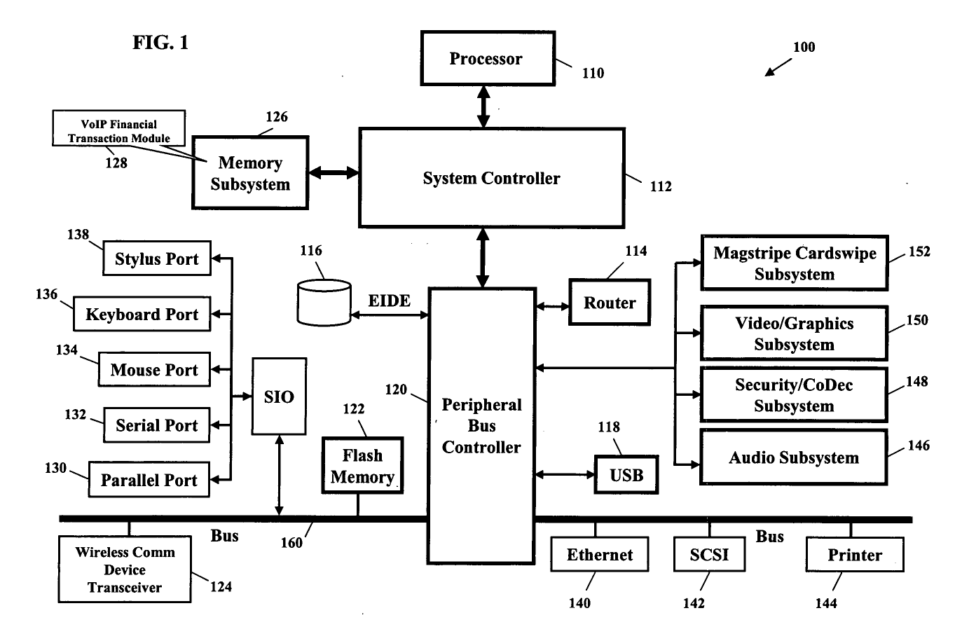

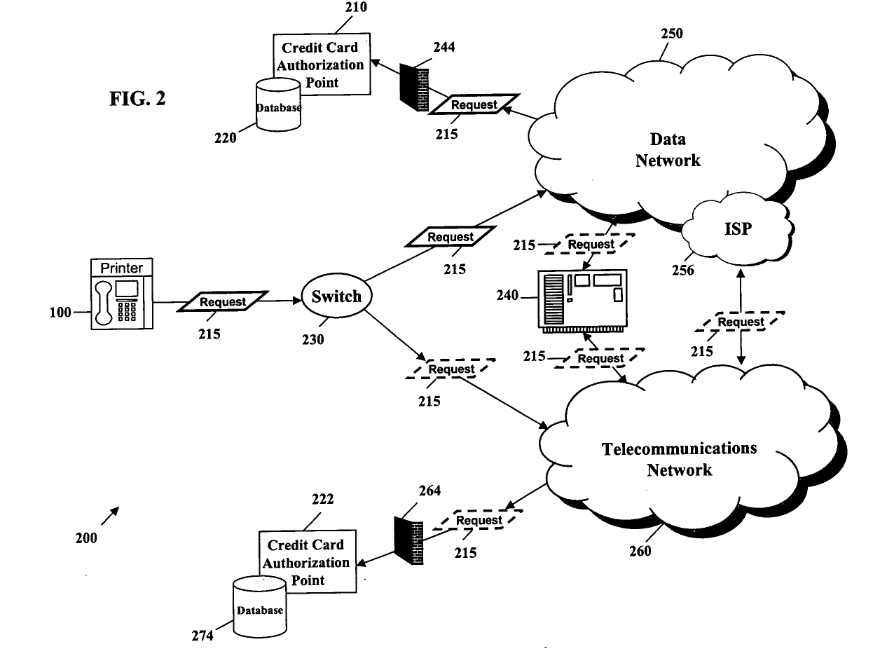

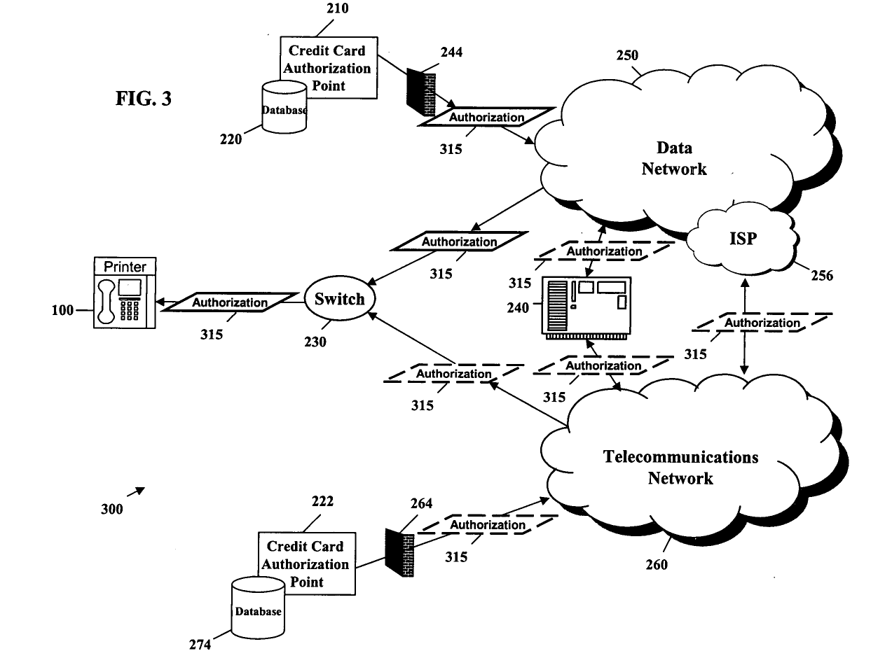

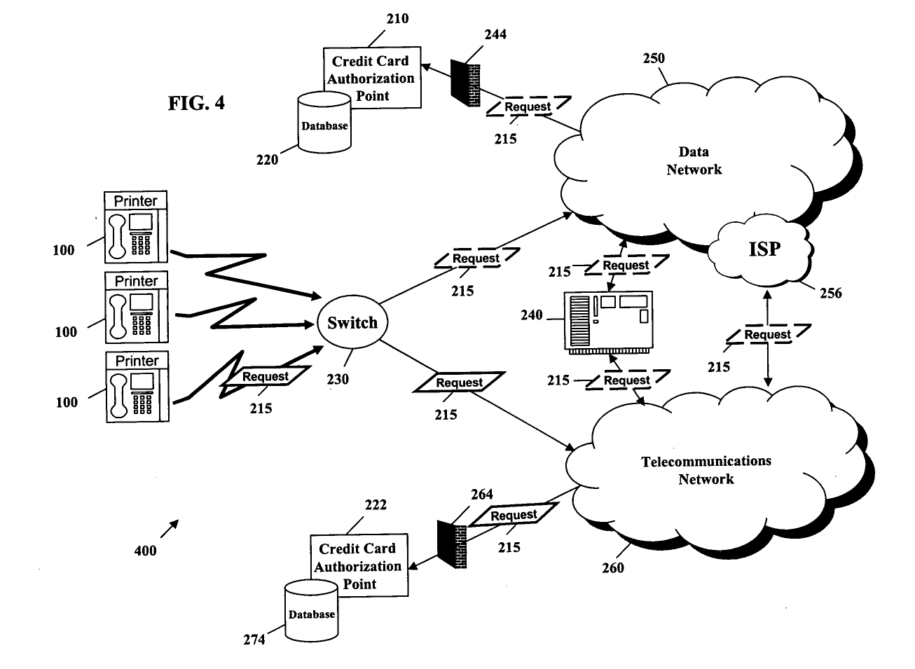

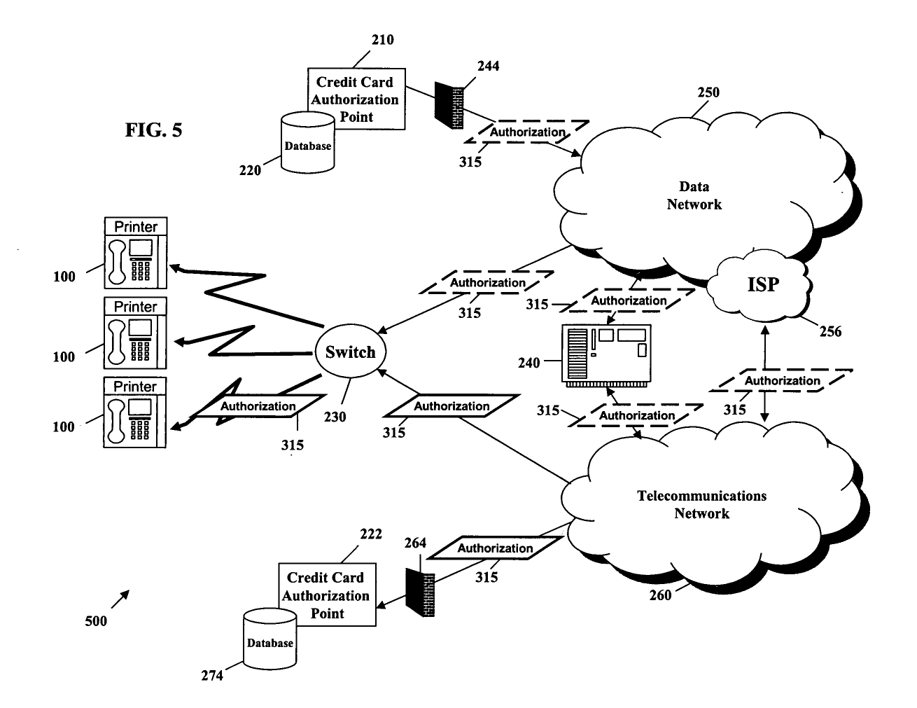

Referring now to the figures, FIG. 1 illustrates an operating system according to embodiments of this invention. FIG. 1 is a block diagram showing the VoIP Financial Transaction Module 128 residing in a computer system shown as a voice/data financial transaction communications device 100. As FIG. 1 shows, the VoIP Financial Transaction Module 128 operates within a system memory device. The VoIP Financial Transaction Module 128, for example, is shown residing in a memory subsystem 126. The VoIP Financial Transaction Module 128, however, could also reside in flash memory 122 or a peripheral storage device 116. The voice/data financial transaction communications device 100 also has one or more central processors 110 executing an operating system. The operating system, as is well known in the art, has a set of instructions that control the internal functions of the voice/data financial transaction communications device 100. A router 114 communicates a communications signal (e.g., a financial transaction request (shown as reference numeral 215 in FIGS. 2 and 4), an authorization (shown as reference numeral 315 in FIGS. 3 and 5), and/or other communications with the voice/data financial transaction communications device 100 and an authorization financial institution communications address (shown as reference numbers 210 and 222 in FIGS. 2-6) and/or an alternate communications address (e.g., an incoming/outgoing phone call, an incoming/outgoing email, and so on). As understood by those of ordinary skill in the art, the router 114 operates with a peripheral bus controller 120 of the voice/data financial transaction communications device 100.

The system controller 112 (typically called the “Northbridge”) provides a bridging function between the one or more central processors 110, a memory subsystem 126, and the peripheral bus controller 120. The peripheral bus controller 120 (typically called a “Southbridge”) controls the PCI (Peripheral Controller Interface) bus 160 and is an integrated circuit that serves as an input/output hub for the router 114, a video/graphics subsystem 150, a magstripe card swipe subsystem 152, a security/CoDec subsystem 148, an audio subsystem 146 and for various peripheral ports and/or transceivers. These peripheral ports allow the voice/data financial transaction communications device 100 to communicate with a variety of devices and/or a communications network through networking ports, such as SCSI 142 or Ethernet 140, and/or transceivers that include wireless communications (“comm”) device transceiver 124 (for wireless communications of any frequency signal in the electromagnetic spectrum, for example, wireless 802.11 and infrared). These peripheral ports could also include other networking ports, such as a serial port 132, a parallel port 130, a mouse port 134, a keyboard port 136, and/or a stylus port 138. The PCI 160 links a printer 144 to the voice/data financial transaction communications device 100 for printing receipts for financial transactions of the device 100. Further, the voice/data financial transaction communications device 100 may include a power source 180, such as a rechargeable battery to provide power and allow the voice/data financial transaction communications device 100 to be portable.

Those of ordinary skill in the art also understand the central processor 110 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

The operating system may be a UNIX® operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, N.C., 1-888-733-4281, www.redhat.com). Other operating systems, however, are also suitable. Such other operating systems would include a WINDOWS-based operating system (WINDOWS® is a registered trademark of Microsoft Corporation, One Microsoft Way, Redmond Wash. 98052-6399, 425.882.8080, www.Microsoft.com) and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

The router 114 may be a Netopia® 3300-ENT Series (Netopia® is a registered trademark of Netopia Corporation, Market Place Tower, Emeryville, Calif. 94608, www.netopia.com). Additionally, other suitable routers by various manufacturers that are known to those of ordinary skill may be used, and therefore will not be further discussed.

The system memory device (shown as memory subsystem 126 and/or peripheral storage device 116) may also contain an application program. The application program cooperates with the operating system and with a display unit to provide a graphical user interface (GUI). The graphical user interface typically allows a user to input a combination of signals (such as signals communicated from the audio subsystem 146, the video/graphics subsystem 150, the magstripe card swipe subsystem, and/or signals from one or more of the peripheral ports, such as the keyboard port 136, and/or alternative input devices). The graphical user interface provides a convenient visual and/or audible interface with the voice/data financial transaction communications device 100.

As shown in FIG. 2, a voice/data financial transactions operating environment 200 includes the voice/data financial transaction communications device 100, having a wired connection to a voice/data communications switch 230, a data communications network 250, a firewall 244, a financial authorization address 210 (also referred to herein as “credit card authorization address,” “financial institution authorization communications address,” or “credit card authorization point”) having a database 220, an Internet Service Provider (ISP) 256, a Voice XML Gateway 240, a telecommunications network 260, another firewall 264 and another credit card authorization point 222 having a database 274. Although FIG. 2 shows the device with a wired connection to the communications switch 230, it is known in the art that the communications connection may be wireless, such as, for example, the wireless communications connection shown in FIGS. 4 and 5. According to embodiments of this invention, the voice/data financial transaction communications device 100 communicates with the data network 250 and/or the telecommunications network 260 via the voice/data communications switch 230. The communications switch 230 may include a packet-based “softswitch” that uses software control to provide voice, data, and video services by dynamically changing its connection data rates and protocol types. In this case an application server interfaces with the switch 230 via a packet protocol, such as Session Initiation Protocol (SIP). In addition, the communications switch 230 may include Advanced Intelligent Network (AIN) componetry controlling many features of the communications with the telecommunications network 260. The communications signaling, connections, and/or logic amongst the communications switch 230, the data network 250, the Voice XML gateway 240, the ISP 256, and the telecommunications network 260, however, are well understood in the art and will not be further described. Additionally, firewalls 244, 264 are also well known in the art and therefore will not be further described.

FIG. 2 illustrates the communications path of a financial transaction request 215 within operating environment 200. According to embodiments of this invention, the VoIP financial transaction communications module (shown in FIG. 1 reference number 128) operates within the voice/data financial transaction communications device 100 to detect and capture data of a financial card medium (e.g., debit card, credit card, gift card, and others). Typically, the financial card data is captured by “swiping” a magnetic strip of the card medium via the magstripe cardreader subsystem (FIG. 1, reference number 152). Alternatively, the financial card data may be entered in another digital and/or analog form. For example, a user may manually enter financial card data. The financial card data includes a financial institution authorization communications address, a card identifier (e.g., debit card, credit card, gift card, and others), an expiration date, a cardholder identifier (e.g., name of cardholder account, billing address, and so on), and a monetary limit for the financial card. The VoIP financial transaction communications module uses the financial card data and other transactional data to create a financial transaction communications request 215. The financial transactional data may include data of a monetary amount of the financial transaction (e.g., for goods and/or services), an identifier of the goods and/or services, a merchant identifier, and/or a financial institution of the merchant. The peripheral bus controller (shown in FIG. 1 as reference number 120) operates with the router (shown in FIG. 1 as reference number 114) to control a communication signal of the financial transaction request 215 to the communications switch 230 of the communications network. The communication signal may include a data communications signal, a voice communications signal, and/or a visual communication signal. The request 215 is routed to the communications switch 230, and the communications switch 230 detects and decodes the financial institution authorization communications address 210 to identify the financial institution authorization communications address 210 as a data communications address or as a telecommunications address. According to some of the embodiments, if the financial institution authorization communications address 210 is a data communications address, then the switch 230 communicates the request 215 to the destination credit card authorization point 210 via the data network 250. According to alternate embodiments, if the financial institution communications address 222 is identified as a telecommunications address, the request 215 may be communicated to a telecommunications destination credit card authorization point 222 via the telecommunications network 260. Still further, the financial request 215 may be communicated via ISP 256 and/or Voice XML Gateway 240 between the data network 250 and the telecommunications network 260. For example, if the financial institution authorization communications address 210 is a data communications address and there is a communications failure (to the data communications address), then the financial card data may include an alternate financial institution authorization communications address (e.g., an alternate telecommunications address since an advantage of today's PSTN is a more reliable communications network) that could be communicated with the request 215 so that the data network 250 routes the request 215 to the telecommunications network 260 for connection with the alternate financial institution authorization communications address 222 when there is a communications failure.

FIG. 3 illustrates a financial transaction communications operating environment 300 similar to the financial transaction communications operating environment 200 of FIG. 2. However, operating environment 300 illustrates the communication of a financial transaction authorization 315 from the credit card authorization point 210 to the voice/data financial transactions communications device 100. After the credit card authorization point 210 receives the financial transaction request (shown in FIG. 2 as reference number 215), the financial institution accesses database 220 (or alternatively database 274), processes the request, and then communicates the authorization 315 (or alternate message) to the voice/data financial transaction communications device 100 via the data network 250 and/or the telecommunications network 260. When the VoIP financial transaction communications module (shown as reference numeral 128 of FIG. 1) receives the authorization 315, the VoIP financial transaction communications module presents the authorization 315 to the voice/data financial transaction communications device 100. According to further embodiment, the VoIP financial transaction communications module may communicate with the printer (shown on the device 100) of the voice/data financial transaction communications device 100 to print out a receipt of the transaction and/or an alternative transactional document (e.g., an email, a text message, and so on).

FIGS. 4 and 5 include respective financial transaction communications operating environments 400 and 500 that are similar to the operating environments 200 and 300 shown in FIGS. 2 and 3. However, operating environments 400 and 500 illustrate multiple voice/data financial transaction communication devices 100 within a merchant's network 402 (e.g., multiple check-out terminals at a grocery store). FIG. 4 illustrates one of the multiple devices 100 wirelessly communicating the request 215 with the communications switch 230 to the financial institution authorization communications address 222 via telecommunications network 260. Alternatively, if the financial transaction authorization communications address 210 is a data communications address, then the switch 230 communicates the request 215 to the financial institution authorization communications address 210 via the data network 250. FIG. 5 shows the financial institution communications address 222 communicating authorization 315 via telecommunications network 260 to the communications switch 230 for communications back to the originating voice/data financial transaction communications device 100 of the network 402. Alternatively, if the financial transaction authorization communications address 210 is a data communications address, then the data network 250 communicates the authorization 315 to the communications switch 230 for communications back to the originating voice/data financial transaction communications device 100 of the network 402. Upon receiving the authorization 315, the voice/data financial transaction communications device 100 processes, presents, and/or otherwise completes the financial transaction. Still, according to further embodiments, the VoIP financial transaction communications module may communicate with the printer (shown on the device 100) of the voice/data financial transaction communications device 100 to print out a receipt of the transaction and/or an alternative transactional document (e.g., an email, a text message, and so on).

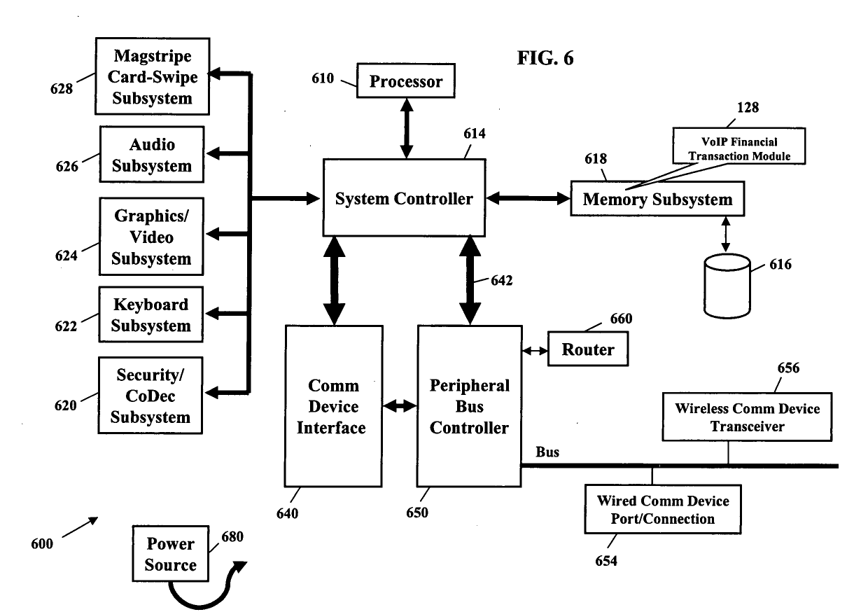

FIG. 6 depicts another block diagram of the VoIP Financial Transaction Module 128 residing in an alternate computer system shown as voice/data financial transactions communications device 600. As FIG. 6 shows, the VoIP Financial Transaction Module 128 operates within a system memory device. The VoIP Financial Transaction Module 128, for example, is shown residing in a memory subsystem 618. The VoIP Financial Transaction Module 128, however, could also reside in a peripheral storage device 616. The voice/data financial transaction communications device 600 also has one or more central processors 610 executing an operating system. The operating system, as is well known in the art, has a set of instructions that control the internal functions of the voice/data financial transaction communications device 600. A communications interface 640 communicates signals, such as a financial transaction request (shown as reference numeral 215 in FIGS. 2 and 4), data signals, control signals, and address signals, between the central processor 610 and a system controller 614 (typically called a “Northbridge”). Additionally, the communications interface 610 has a means to communicate the communications signal between the voice/data financial transaction communications device 600 and a communications network (such as a data network shown as reference number 250 in FIGS. 2-5 and a telecommunications network shown as reference number 260 in FIGS. 2-5).

The system controller 614 provides a bridging function between the one or more central processors 610, a video/graphics subsystem 624, a keyboard subsystem 622, an audio subsystem 626, a magstripe card swipe subsystem 628, a security/CoDec subsystem 620, the memory subsystem 618, a PCI (Peripheral Controller Interface) bus 650, and a Communications (“Comm”) Device Interface 640. The PCI bus 642 is controlled by a Peripheral Bus Controller 650. The Peripheral Bus Controller 650 (typically called a “Southbridge”) is an integrated circuit that serves as an input/output hub for a router 660 and for various peripheral ports and/or transceivers. The router 660 operates with the peripheral bus controller 650 to allow for communications with a communications network (e.g., routing a financial transaction request to the credit card authorization address). The peripheral ports allow the voice/data financial transaction communications device 600 to communicate with a variety of devices through networking ports (such as SCSI or Ethernet, not shown) and/or transceivers that include Wireless Communications (“Comm”) Device Transceiver 656 (for communication of any frequency signal in the electromagnetic spectrum, such as, for example, Wireless 802.11 and Infrared) and Wired Communications (“Comm”) Device Port/Connection 654 (such as modem V90+ and compact flash slots). These peripheral ports could also include other networking ports, such as, a serial port (not shown) and/or a parallel port (not shown). In another embodiment, the voice/data financial transaction communications device 600 may include a power source 680, such as a rechargeable battery to provide power and allow the voice/data financial transaction communications device 600 to be portable. In alternate embodiments, the router 660 may be an alternative router known by those of ordinary skill in the art. Additionally, those of ordinary skill in the art understand that the program, processes, methods, and systems described in this patent are not limited to any particular computer system or computer hardware.

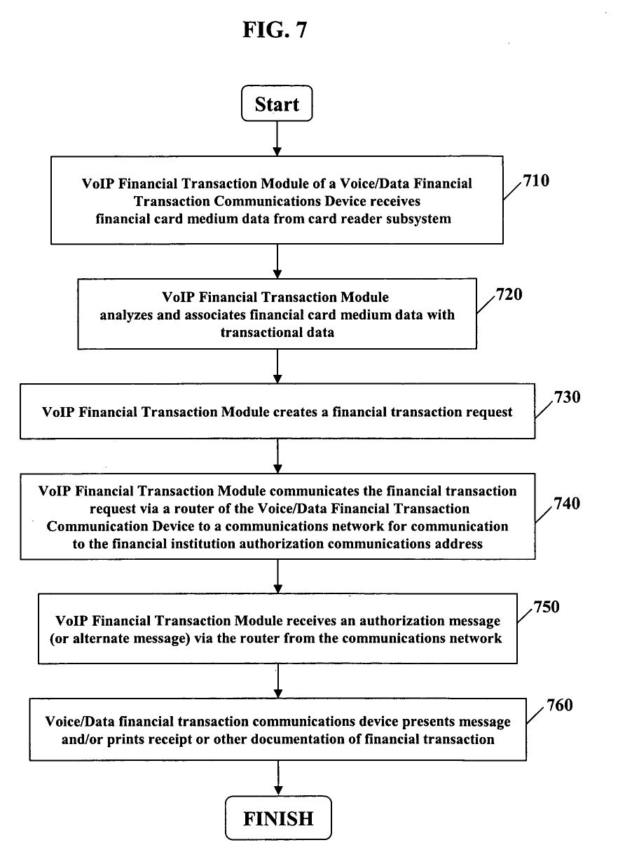

FIG. 7 illustrates a flowchart of a method for providing voice/data financial transaction communications according to some of the exemplary embodiments of this invention. A Voice over Internet Protocol (VoIP) phone having a VoIP Financial Transaction Module, an integrated router, and an integrated credit card processing terminal (also referred to as a “voice/data financial transaction communications device”) receives a financial card medium's financial data from a card reader subsystem [block 710]. The VoIP Financial Transaction Module analyzes and associates the financial card medium data with transactional data including merchant data, merchandise identifiers, and a monetary value of the financial transaction [block 720], and the VoIP Financial Transaction Module creates a financial transaction request [block 730]. The VoIP Financial Transaction Module instructs the router to communicate the financial transaction request to a financial institution authorization communications address via a communications network [block 740]. In response to the request, an authorization (or alternate message) is communicated from the financial institution authorization communications address to the voice/data financial transaction communications device via the communications network [block 750]. Thereafter, the VoIP Financial Transaction Module presents the authorization to the voice/data financial transactions communications device and instructs a print (may be integrated or stand alone) to print a receipt of other documentation of the financial transaction [block 760].

The VoIP Financial Transaction Module (shown as reference numeral 128 in FIGS. 1 and 6) may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the VoIP Financial Transaction Module to be easily disseminated.

The VoIP Financial Transaction Module may be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol phone, or a wireless pager.

While this invention has been described with respect to various features, aspects, and embodiments, those skilled and unskilled in the art will recognize this invention is not so limited. Other variations, modifications, and alternative embodiments may be made without departing from the spirit and scope of this invention.

What is claimed is:

1. A voice/data financial transaction communications device, comprising:
a voice over internet protocol communications device having a router for communications with a communications network, a card reader subsystem for reading a payment medium, a Voice over Internet Protocol Financial Transactions Module stored in a memory device, and a processor communicating with the memory device,
the Voice over Internet Protocol Financial Transactions Module,
receiving data of a financial card medium from the card reader subsystem, the financial medium data identifying at least one of a financial institution authorization communications address, a card identifier, a cardholder, an expiration date, and a monetary limit for a financial transaction,
communicating a financial transaction request to the financial institution authorization communications address via the communications network, the request comprising the financial medium data, merchant data, and a monetary amount, the merchant data identifying at least one of a merchant communications address, a merchant identifier, and a financial institution of the merchant, and
receiving an authorization from the financial institution authorization communications address for the requested monetary amount.

2. The voice/data financial transaction communications device of claim 1, further comprising:
a keyboard subsystem for communicating data with the voice over internet protocol communications device.

3. The voice/data financial transaction communications device of claim 2, wherein the keyboard subsystem comprises at least one of the following:
a keyboard;
a mouse; and
a stylus.

4. The voice/data financial transaction communications device of claim 1, further comprising:
a display for communicating visual data with the voice over internet protocol communications device.

5. The voice/data financial transaction communications device of claim 1, further comprising:
an audio subsystem for communicating audio data with the voice over internet protocol communications device.

6. The voice/data financial transaction communications device of claim 1, further comprising:
a power source for the voice over internet protocol communications device.

7. The voice/data financial transaction communications device of claim 6, wherein the power source is a battery power source.

8. The voice/data financial transaction communications device of claim 1, further comprising:
a peripheral bus controller operating with the router to control communications signals with a communications switch of the communications network, the communications signals comprising at least one of the request, the authorization, and a voice communications signal, the voice communications signal from the voice/data financial transaction communications device to another communications address.

9. The communications system of claim 8, wherein the communications switch comprises a voice and data switch, the voice and data switch establishing a communications connection with at least one of a telecommunications network and a data network.

10. The voice/data financial transaction communications device of claim 1, further comprising:
a printer for printing out a receipt associated with at least one of the request and the authorization.

11. A voice/data financial transaction communications device, comprising:
at least one input/output processor to access, input, and output at least one of data of a financial card medium, a financial transaction request, and an authorization for the financial transaction request;
at least one router for routing a communications signal of at least one of the financial medium data, the financial transaction request, and the authorization for the financial transaction request to a communications network;
a memory device for storing a Voice over Internet Protocol Financial Transaction Module; and
a processor communicating with the memory device, the processor operating with Voice over Internet Protocol Financial Transaction Module for processing at least one of the financial card medium, the request, and the authorizations.

12. The voice/data financial transaction communications device of claim 11, further comprising at least one of:
a graphics/video subsystem;
a keyboard subsystem;
an audio subsystem;
a magstripe card swipe subsystem; and
a security codec subsystem.

13. The voice/data financial transaction communications device of claim 12, further comprising:
at least one of a wireless communications transceiver and a wired communications port for communicating the communications signal via the router with at least one of the communications network and another communications device.

14. The voice/data financial transaction communications device of claim 13, the Voice over Internet Protocol Financial Transaction Module:
receiving the data of the financial card medium from the card reader subsystem, the financial medium data identifying at least one of a financial institution authorization communications address, a card identifier, a cardholder, an expiration date, and a monetary limit for a financial transaction,
communicating the financial transaction request to the financial institution authorization communications address via the communications network, the request comprising the financial medium data, merchant data, and a monetary amount, the merchant data identifying at least one of a merchant communications address, a merchant identifier, and a financial institution of the merchant, and
receiving the authorization from the financial institution authorization communications address for the requested monetary amount.

15. A computer program product, comprising:
a computer-readable medium; and
a Voice over Internet Protocol financial transaction module stored on the computer-readable medium, the Voice over Internet Protocol Financial Transactions Module:
receiving data of a financial card medium from the card reader subsystem, the financial medium data identifying at least one of a financial institution authorization communications address, a card identifier, a cardholder, an expiration date, and a monetary limit for a financial transaction,
communicating a financial transaction request to the financial institution authorization communications address via the communications network, the request comprising the financial medium data, merchant data, and a monetary amount, the merchant data identifying at least one of a merchant communications address, a merchant identifier, and a financial institution of the merchant, and
receiving an authorization from the financial institution authorization communications address for the requested monetary amount.

16. The computer program product of claim 15, wherein the computer-readable medium is stored to a voice-over internet protocol communications device.

17. The computer program product of claim 15, wherein the computer-readable medium is stored to a computer system.
